(19) United States
(12) Patent Application Publication
(10) Pub. No.: US 2014/0164121 A1
(43) Pub. Date: Jun. 12, 2014

(54) COUPON DISPLAY SYSTEM

(71) Applicant: EBAY INC., San Jose, CA (US)

(72) Inventors: Brian William Payne, San Jose, CA (US); Liem Duy Nguyen, San Jose, CA (US); Sarmishta Pantham, Fremont, CA (US); Noah Batterson, Savannah, GA (US)

(73) Assignee: eBay Inc., San Jose, CA (US)

(21) Appl. No.: 13/708,517

(22) Filed: Dec. 7, 2012

(51) Int. Cl. G06Q 30/02

(52) U.S. Cl. CPC G06Q 30/0261
USPC 705/14.58

(57) ABSTRACT

According to various exemplary embodiments, an electronic message including a coupon is detected in an electronic message inbox associated with a user. A redemption location associated with the coupon is determined. Thereafter, a notification is displayed via a user interface in a mobile device associated with the user, when the mobile device is located within a predetermined distance of the redemption location.

### TECHNICAL FIELD

The present application relates generally to electronic user interfaces and, in one specific example, to a coupon display system.

### BACKGROUND

Coupons are generally tickets or documents that can be exchanged for a financial discount when purchasing a product. For example, coupons may be issued by a retailer for use in the retailer's stores as part of a sales promotion. Such coupons may be distributed to a consumer via, for example, internet websites, newspapers, magazines, regular mail, and so on. In order to redeem the coupon and obtain the financial discount for a product being purchased, the consumer typically presents the coupon in the appropriate retail store at the time of purchase.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flowchart illustrating an example method, according to various embodiments.

FIG. 4 illustrates an example of message inbox information, according to various embodiments.

FIG. 5 illustrates an example of an e-mail message, according to various embodiments.

FIG. 6a illustrates an example of coupon keyword information, according to various embodiments.

FIG. 6b illustrates an example of coupon source address information, according to various embodiments.

FIG. 7 illustrates an example of retailer information, according to various embodiments.

FIG. 8 illustrates an example of a notification, according to various embodiments.

FIG. 9a is a flowchart illustrating an example method, according to various embodiments.

FIG. 9b is a flowchart illustrating an example method, according to various embodiments.

FIG. 10 is a flowchart illustrating an example method, according to various embodiments.

FIG. 11 is a flowchart illustrating an example method, according to various embodiments.

FIG. 12 illustrates an example of a notification, according to various embodiments.

FIG. 13 is a flowchart illustrating an example method, according to various embodiments.

FIG. 14 illustrates an example of a user interface, according to various embodiments.

FIG. 15 illustrates an example of a notification, according to various embodiments.

FIG. 16 illustrates an example of a user interface, according to various embodiments.

FIG. 17 illustrates an example of an e-mail message, according to various embodiments.

FIG. 18 illustrates an example of a notification, according to various embodiments.

FIG. 19 is a diagrammatic representation of a machine in the example form of a computer system within which a set of instructions, for causing the machine to perform any one or more of the methodologies discussed herein, may be executed.

### DETAILED DESCRIPTION

Example methods and systems to display coupons are described. In the following description, for purposes of explanation, numerous specific details are set forth in order to provide a thorough understanding of example embodiments. It will be evident, however, to one skilled in the art that the present invention may be practiced without these specific details.

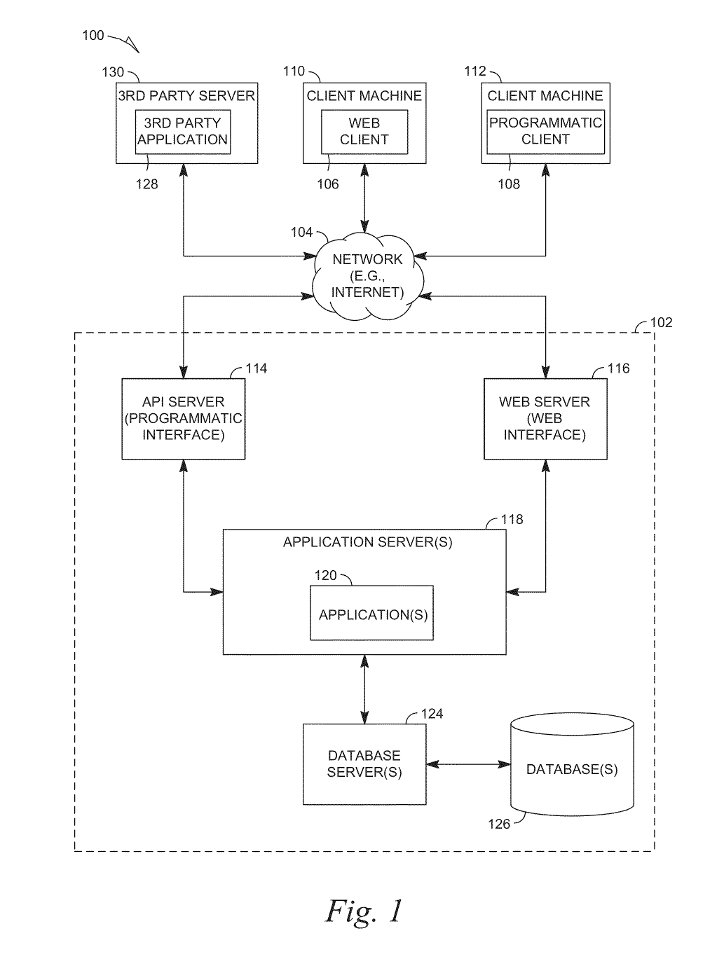

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

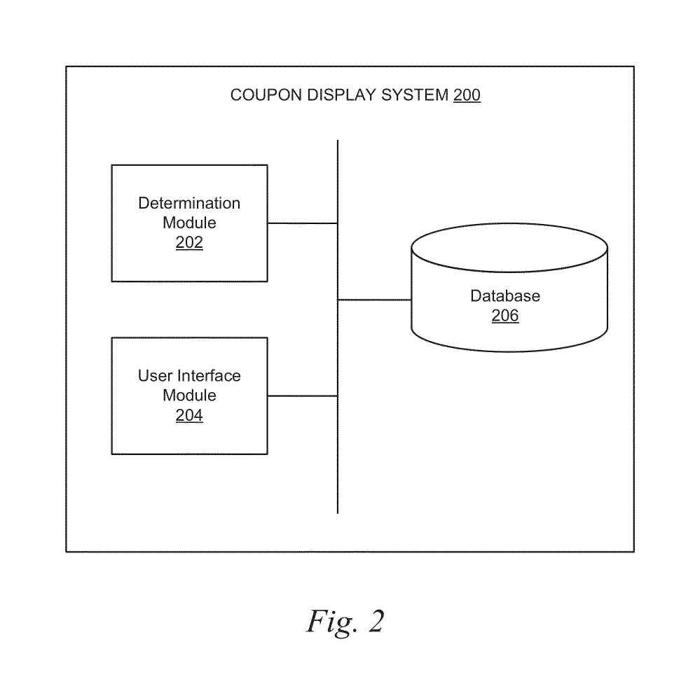

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a coupon display system 200 includes a determination module 202, a user interface module 204, and a database 206. The modules of the coupon display system 200 may be implemented on a single device such as a coupon display device, or on separate devices interconnected via a network. The aforementioned coupon display device may correspond to, for example, one of the client machines (e.g. 110, 112) or application server(s) 118 illustrated in FIG. 1.

E-mail inboxes of many users often contain a large number of e-mails that include coupons. In many cases, the e-mails and coupons are accurately targeted at the genuine interests of the user. For example, the user may receive such e-mails from a retailer because they have previously researched or purchased a product from the retailer, often through an in-store purchase at a bricks and mortar store of the retailer, or through an online purchase from a website associated with the retailer. During such interactions, the retailer comes to be in possession of the e-mail address of the user, and thus the retailer transmits e-mails to the user with coupons for sales promotions at that retailer. However, many users do not read such e-mails or take advantage of such coupons, often due to lack of time or a lack of awareness of convenient locations where these coupons may be redeemed.

Thus, according to various embodiments described herein, the coupon display system 200 is configured to scan a user's e-mail inbox for e-mails that include coupons, and determine a redemption location associated with each of the coupons. The redemption location may correspond to, for example, a location such as retail store where the coupon may be redeemed during purchase of a product or service. Thereafter, when the user is within a predetermined distance of the redemption location, the coupon display system 200 displays a notification on a mobile device (e.g., a smart phone) of the user, alerting the user of the coupon and the user's proximity to the retail store where the coupon may be redeemed. Instead, or in addition, the coupon display system 200 may display the notification when there is a specific time interval remaining before the coupon expires, in order to encourage the user to take advantage of a coupon that expires soon, for example. Further, the user may share these coupons with others, so that when the user's friend is within a predetermined distance of the redemption location of a coupon, the aforementioned notification is displayed to the user's friend on their own mobile device.

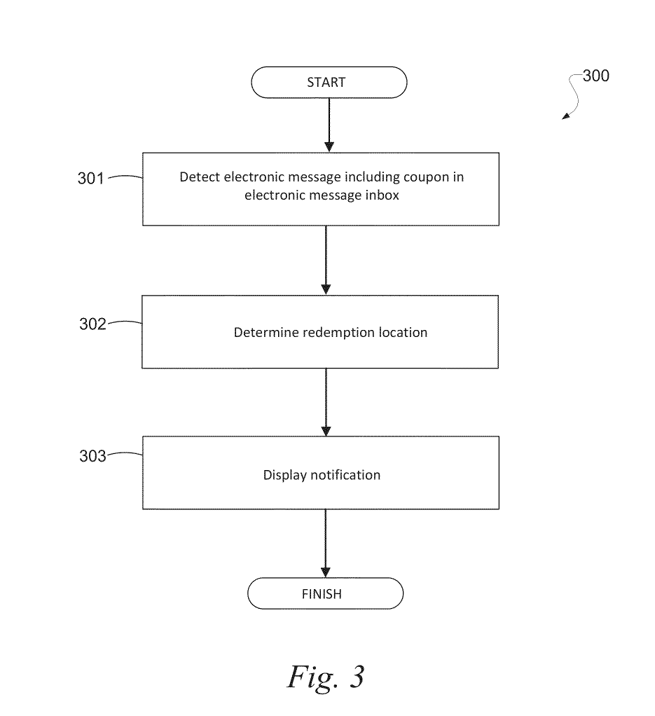

FIG. 3 is a flowchart illustrating an example method 300, according to various embodiments. The method 300 may be performed at least in part by, for example, the coupon display system 200 illustrated in FIG. 2 (or an apparatus having similar modules, such as client machines 110 and 112 or application server 112 illustrated in FIG. 1). In 301, the determination module 202 detects, in an electronic message inbox associated with the user, an electronic message including a coupon. In 302, the determination module 202 determines a redemption location associated the coupon. As described herein, a redemption location of a coupon corresponds to a location (e.g., retail store) where the coupon may be redeemed when purchasing a product or service. In 303, the user interface module 204 displays a notification via a user interface in a mobile device associated with the user, when the mobile device is located within a predetermined distance of the redemption location calculated in 302. The notification may display the coupon, and inform the user of their proximity to the redemption location associated with the coupon.

Each of the aforementioned operations 301-303, and each of the aforementioned modules of the coupon display system 200, will now be described in greater detail. For simplicity, various examples below refer to an e-mail message as an example of an electronic message, and an e-mail inbox as an example of an electronic message inbox. However, it is apparent that the embodiments of this disclosure are applicable to other types of electronic messages, such as text messages, short message service (SMS) messages, multimedia message service (MMS) messages, instant messages, social media messages, etc., as well as the corresponding electronic message inboxes of each type of message.

Referring back to FIG. 3, in 301, the determination module 202 detects, in an e-mail inbox associated with the user, an e-mail message including a coupon. As understood by those skilled in the art, an e-mail inbox is an e-mail repository or storage location associated with a particular e-mail address, such that any dispatched e-mails directed to that particular e-mail address are received and stored in the e-mail inbox. The e-mail inbox may be stored locally in the database 206 illustrated in FIG. 2. Alternatively, the e-mail inbox may be located remotely at an e-mail server or other application server, a remote data repository, a cloud storage location accessible via the Internet, and so on. Thus, the determination module 202 may access the message inbox of the user by, for example, connecting to the appropriate e-mail server or other repository via a network (e.g., the Internet), in order to access the electronic data corresponding to the e-mail inbox of the user, hereinafter referred to as “e-mail inbox information”.

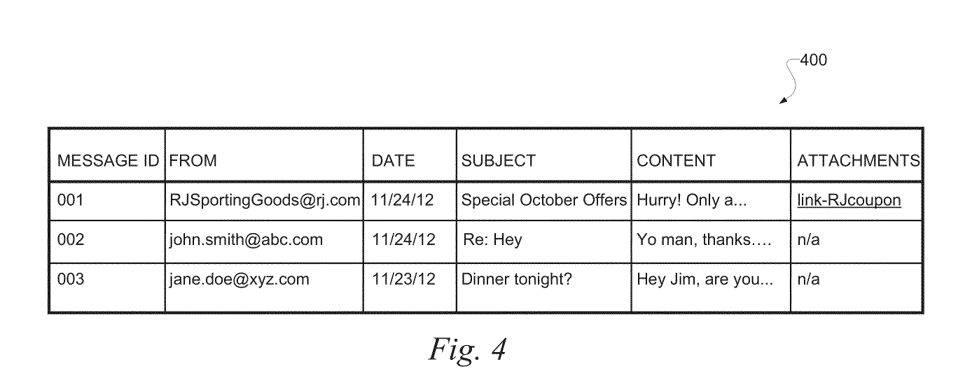

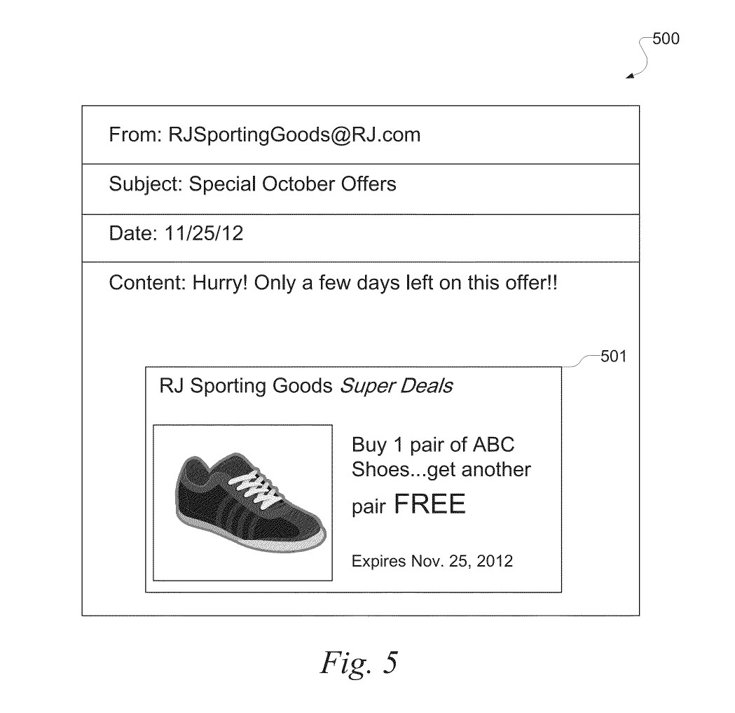

For example. FIG. 4 illustrates e-mail inbox information 400 corresponding to the contents of an e-mail inbox associated with a user, including various information regarding multiple e-mails received by the user. More specifically, the e-mail inbox information 400 identifies, for each e-mail, an identifier of the message in the “Message ID” column (e.g., “002”), a source e-mail address of the message in the “From” column (e.g., “john.smith@abc.com”), a reception date/time when the message was received in the “Date” column (e.g., “11/24/12”), a subject line of the message in the “Subject” (e.g., “Re: Hey”), the content of the message in the “Content” column, and any attachments to the message in the “Attachment” column. FIG. 5 illustrates an example of an e-mail 500 that corresponds to the e-mail with message “ID 001” in the e-mail inbox information 400 in FIG. 4. The e-mail 500 includes various information in the “From” field, “Subject” field, “Date” field, and “Content” field, that corresponds to the information in the corresponding fields of the e-mail inbox information 400. E-mail 500 includes a coupon 501 for a retailer RJ Sporting Goods. The coupon 501 may be represented by electronic data or URL link in the “Content” field, or as an attachment in the “Attachment” field in the e-mail inbox information 400 in FIG. 4.

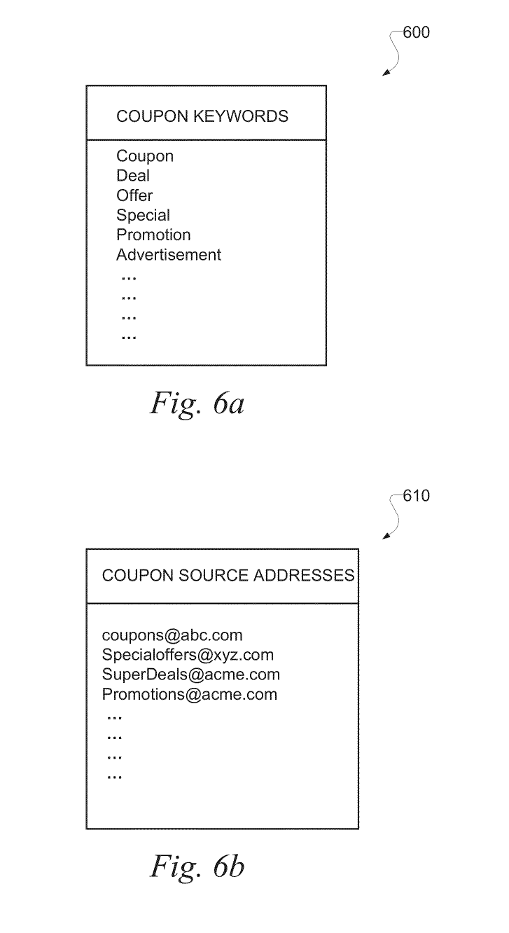

According to various exemplary embodiments, the determination module 202 may detect an e-mail message that includes a coupon in the e-mail inbox of the user, by scanning each e-mail in the e-mail inbox of the user, and checking the contents of each e-mail (or metadata associated with each email) against a list of known “coupon keywords” (i.e., words known to be associated with coupons and/or e-mails that include coupons). For example, FIG. 6a illustrates an example of coupon keyword information 600 that identifies a number of known coupon keywords, such as “coupon”, “deal”, “offer”, “special”, “promotion”, “advertisement”, etc. Thus, the determination module 202 may compare keywords in the content, subject line, attachments, title/URL of the attachments, etc., of each e-mail with the coupon keywords in the coupon keyword information 600, in order to detect if there is a match between a keyword in the e-mail message (or metadata associated with each email) and one of the known coupon keywords. For example, with reference to the e-mail 500 illustrated in FIG. 5, the determination module 202 may determine that the subject line includes the coupon keywords “Special” and “Offers”, while the content includes the coupon keyword “Offer”, and the coupon 501 in the content/attachment of the e-mail 500 includes the coupon keyword “Deals”. Thus, the determination module 202 may determine that the e-mail 500 is an e-mail that includes a coupon.

According to another exemplary embodiment, the determination module 202 may detect an e-mail message that includes a coupon in the e-mail inbox of the user, by scanning each e-mail in the e-mail inbox of the user, and checking the source/sender e-mail address of each e-mail against a list of the known “coupon source addresses” (i.e., the known e-mail addresses of sources/senders known to transmit e-mails that include coupons). For example, FIG. 6b illustrates an example of coupon source address information 610 that identifies a number of known coupon source addresses. Thus, the determination module 202 may compare the source/sender e-mail address of each e-mail with the coupon source addresses in the coupon source address information 610, in order to detect if there is a match between a source e-mail address of the e-mail message and one of the known coupon source addresses. For example, if the source e-mail address of “RJSportingGoods@RJ.com” of the e-mail 500 illustrated in FIG. 5 is included in the coupon source address information 610, then the determination module 202 may determine that the e-mail 500 is an e-mail that includes a coupon.

Referring back to FIG. 3, in 302, the determination module 202 determines a redemption location associated with each of one or more coupons. As described above, a redemption location of a coupon corresponds to a location where the coupon may be redeemed when purchasing a product or service. For example, if the coupon is issued by a retailer for use in the retailer's stores as part of a sales promotion, then in order to redeem the coupon and obtain the financial discount for a product being purchased, the consumer typically presents the coupon in the appropriate retail store at the time of purchase. Thus, in this example, such a retail store would correspond to the redemption location of the coupon. According to an embodiment, if the coupon includes an address directly within the text of the coupon, the determination module 202 may determine that this address is the redemption location associated with a coupon. For example, the determination module 202 may perform a text analysis of the content or information (e.g., text or words) included in the coupon, and search for text or words corresponding to an address.

According to another embodiment, the determination module 202 may determine a redemption location associated with a coupon, by (a) determining a retailer (or other entity, such as a business, enterprise, organization, etc.) associated with the coupon, and (b) determining a location associated with this retailer. For example, the coupon 501 in FIG. 5 is issued by the retailer RJ Sporting Goods. Thus, the determination module 202 may determine the redemption location associated with the coupon 501 by (a) determining that the coupon 501 is associated with the retailer RJ Sporting Goods, and then (b) determining a location associated with retailer RJ Sporting Goods.

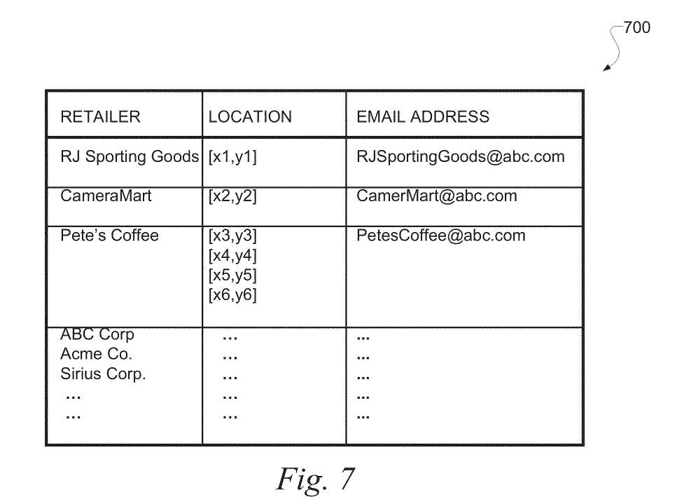

The determination module 202 may determine a retailer associated with a coupon by performing a text analysis of the content or information (e.g., text or words) included in the coupon, and searching for keywords corresponding to the name of a retailer in the content of the coupon. For example, the determination module 202 may access a list of retailers, and check if any of these retailers in the list are referenced by the text of the coupon 501. The aforementioned list may be embodied as retailer information 700 as shown in FIG. 7, which includes the names of various retailers. The retailer information 700 may, for example, be stored in database 206 illustrated in FIG. 2, or may be accessed from a remote location via a network (e.g., the Internet). Thus, if the words in the name of a retailer listed in the retailer information 700 (e.g., “RJ” and “Sporting” and “Goods”) are detected by the determination module 202 in the coupon 501 through text analysis, the determination module 202 may determine that the corresponding retailer in the retailer information 700 (i.e., “RJ Sporting Goods”) is associated with the coupon 501.

According to another embodiment, the determination module 202 may check the source email address of the email message 500 that included the coupon 501 against a list of known email addresses of retailers. For example, the retailer information 700 may identify the email addresses associated with various retailers, as seen in FIG. 7. Thus, if the source email address of the email message 500 that included the coupon 501 matches the known email address of a given retailer listed in the retailer information 700, the determination module 202 may determine that the coupon 501 is associated with this given retailer.

After the determination module 202 determines a retailer associated with the coupon, the determination module 202 may determine the location associated with the retailer (i.e., the redemption location) by accessing information indicating a plurality of retailers and locations associated with each of the retailers. For example, the aforementioned retailer information 700 of FIG. 7 lists a plurality of retailers (e.g., RJ Sporting Goods, CameraMart, etc.), and locations associated with each of the retailers (e.g., [x1, y1], [x2, y2], etc.). The locations in the retailer information 700 illustrated in FIG. 7 are represented by exemplary generic location coordinates (e.g., [x1, y1]), which may correspond to geographic coordinates, global positioning system (GPS) coordinates, latitude & longitude coordinates, street addresses, etc., or any other metric for measuring or describing location that are known by those skilled in the art.

Thus, in the example above, the determination module 202 may determine that the redemption location associated with the coupon 501 is [x1, y1], by determining that the coupon 501 is associated with the retailer RJ Sporting Goods, and by determining that the retailer RJ Sporting Goods is associated with the location [x1, y1]. Note that a retailer may be associated with multiple locations (such as multiple branches or franchises in retail chain). For example, as illustrated in the retailer information 700, the retailer Pete's Coffee is associate with multiple locations: [x3, y3], [x4,y4], [x5,y5]. In this case, the determination module 202 may identify the redemption location closest to the current location of the user (or the user's mobile device) as the corresponding redemption location associated with any Pete's Coffee coupon. Examples of how the current location of the user (or the user's mobile device) may be determined are described in more detail below. In this example, if the Pete's Coffee location [x3, y3] is closest to the current location of the user (when compared to the Pete's Coffee locations [x4,y4] and [x5,y5]), then the determination module 202 will determine that the redemption location associated with a Pete's Coffee coupon is [x3, y3].

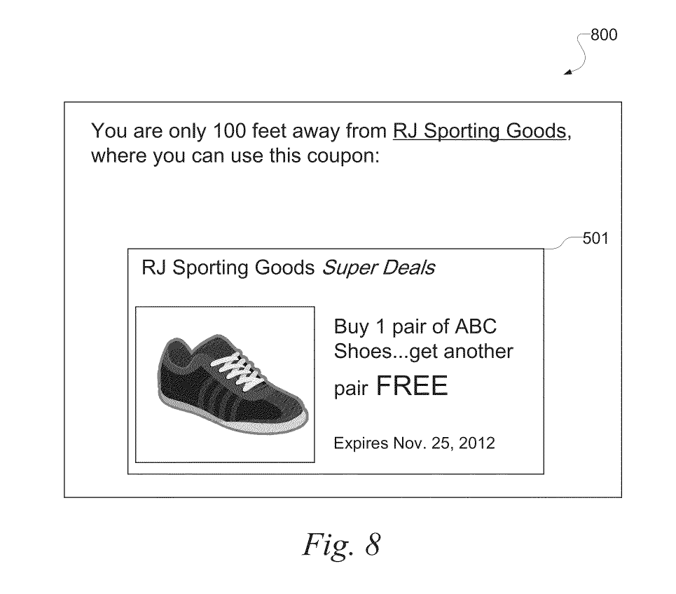

Referring back to FIG. 3, in 303, the user interface module 204 displays a notification, via a user interface on a mobile device associated with the user, when the mobile device of the user is located within a predetermined distance of the redemption location calculated in 302. The notification may display the coupon, and inform the user of their proximity to the redemption location associated with the coupon. For example, FIG. 8 illustrates an example of the notification 800 that displays the coupon 501 that was included in the e-mail 500 (see FIG. 5). The notification 800 informs the user of their proximity (e.g., “100 feet”) to the redemption location or retailer “RJ Sporting Goods” that is associated with the coupon 501

The determination module 202 may determine the current location of the mobile device of the user (and/or whether the mobile device is within a predetermination distance of the redemption location of a coupon) based on geo-location information accessed from the mobile device associated with the user (e.g., client machines 110, 112 illustrated in FIG. 1). The geo-location information may be generated by the mobile device based on, for example, a GPS system included in the mobile device, or a location module of the mobile device that performs an analysis of signal strength from nearby telecommunications towers proximate to the mobile device, or other methods well understood by those skilled in the art.

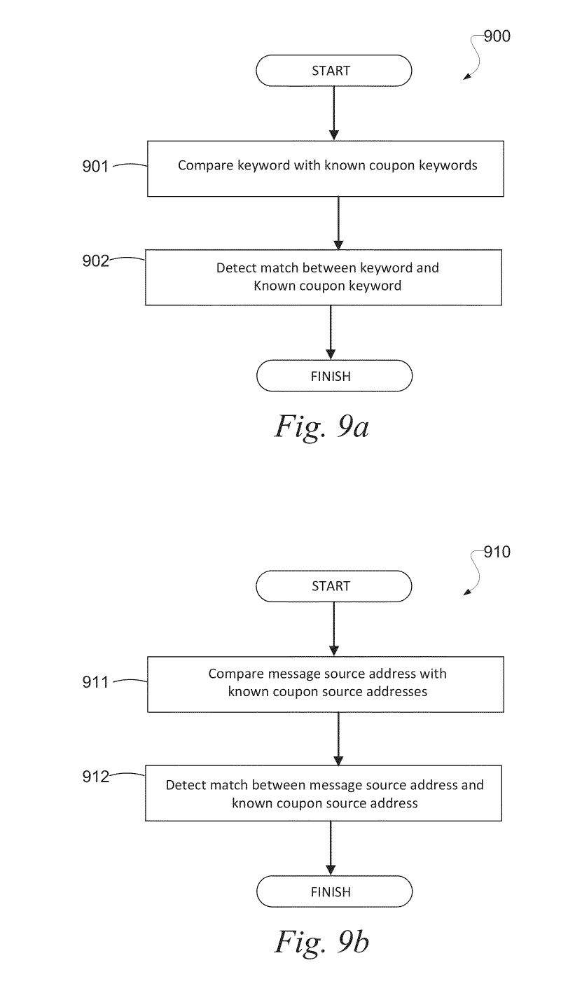

FIG. 9a is a flowchart illustrating an example method 900 for determining that an electronic message includes a coupon, according to various embodiments described above. The method 900 may replace 301 in the method 300 illustrated in FIG. 3. The method 900 may be performed at least in part by, for example, the coupon display system 200 illustrated in FIG. 2 (or an apparatus having similar modules, such as client machines 110 and 112 or application server 112 illustrated in FIG. 1). In 901, the determination module 202 compares a keyword in the content of an electronic message (e.g., see FIG. 5) with a database listing a plurality of known coupon keywords (e.g., see FIG. 6a). In 902, the determination module 202 detects a match between the keyword in the electronic message and one of the known coupon keywords in the database listing.

Similarly, FIG. 9b is a flowchart illustrating another example method 910 for determining that an electronic message includes a coupon, according to various embodiments described above. The method 910 may replace 301 in the method 300 illustrated in FIG. 3. The method 910 may be performed at least in part by, for example, the coupon display system 200 illustrated in FIG. 2 (or an apparatus having similar modules, such as client machines 110 and 112 or application server 112 illustrated in FIG. 1). In 911, the determination module 202 compares a message source address associated with an electronic message (e.g., see FIG. 5) with a database listing a plurality of known coupon source addresses (e.g., see FIG. 6b). In 912, the determination module 202 detects a match between the message source address of the electronic message and one of the known coupon source addresses.

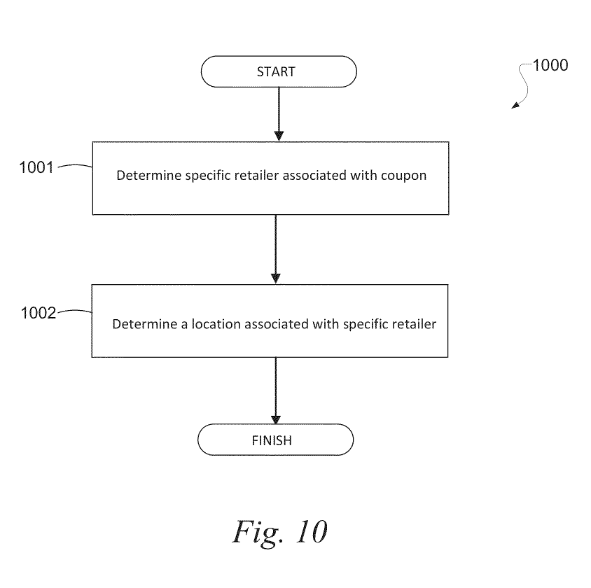

FIG. 10 is a flowchart illustrating an example method 1000 for determining a redemption location associated with a coupon, according to various embodiments described above. The method 1000 may replace 302 in the method 300 illustrated in FIG. 3. The method 1000 may be performed at least in part by, for example, the coupon display system 200 illustrated in FIG. 2 (or an apparatus having similar modules, such as client machines 110 and 112 or application server 112 illustrated in FIG. 1). In 1001, the determination module 202 determines a specific retailer associated with a coupon included in an electronic message. For example, the determination module 202 may compare a keyword in the content of the electronic message (e.g., the words/characters “RJ Sporting Goods” in the e-mail message 500 in FIG. 5) with retailer information (e.g. see FIG. 7) listing a plurality of names associated with a plurality of known retailers, and the determination module 202 may then detect a match between the keyword in the content of the electronic message and a name of a specific retailer identified in the retailer information. In 1002, the determination module 202 determines a location associated with the specific retailer determined in 1001. For example, the aforementioned retailer information (e.g., see FIG. 7) may list a plurality of known locations associated with each of the retailers, and the determination module 202 may thereby identify the location associated with the retailer determined in 1001.

According to various embodiments, the determination module 202 may determine an expiration date associated with each coupon, in addition to determining a redemption location associated with the coupon as described above. Thus, the user interface module 204 may display a notification when there is a certain amount of time remaining before the coupon expires, and/or when the user is in close proximity to the redemption location of the coupon.

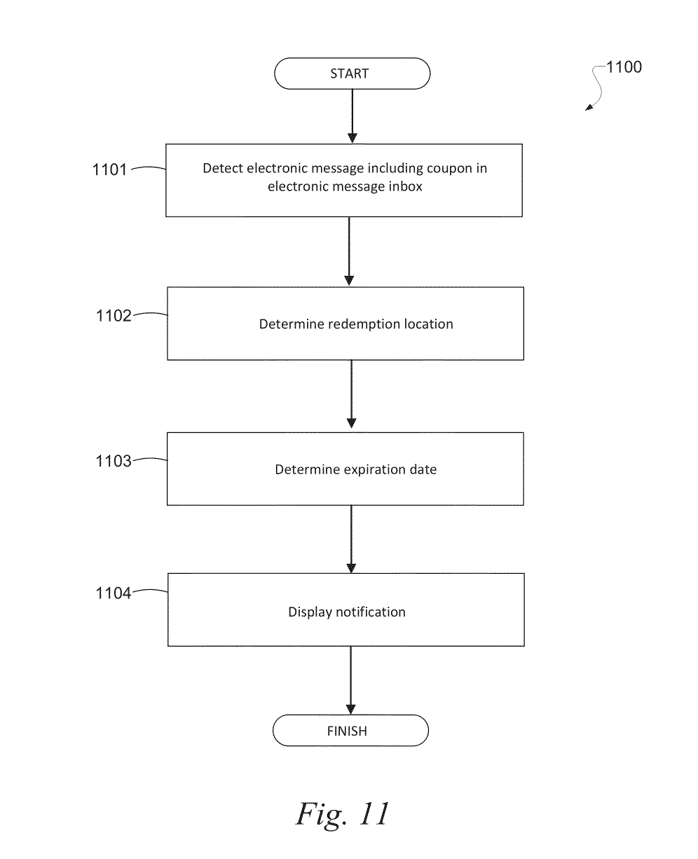

For example, FIG. 11 is a flowchart illustrating an example method 1100, according to various embodiments. The method 1100 may be performed at least in part by, for example, the coupon display system 200 illustrated in FIG. 2 (or an apparatus having similar modules, such as client machines 110 and 112 or application server 112 illustrated in FIG. 1). 1101 and 1102 are similar to 301 and 302 in the method 300 (see FIG. 3). That is, in 1101, the determination module 202 detects, in an electronic message inbox associated with the user, an electronic message including a coupon, and in 1102, the determination module 202 determines a redemption location associated the coupon.

In 1103, the determination module 202 determines an expiration time and/or date associated with the coupon. The determination module 202 may determine an expiration time associated with a coupon by performing a text analysis of the content or information (e.g., text or words) included in the coupon, and searching for keywords or characters indicative of an expiration date. For example, the determination module 202 may locate the words “expire”, “expires”, “expiration”, “valid until”, etc., in the coupon, and any times or dates following such words (e.g., “Nov. 25, 2012”, or “11/25/12”) may be identified by the determination module 202 as the expiration time/date associated with the coupon. Thus, the determination module 202 may determine that the expiration time of the coupon 501 (see FIG. 5) is Nov. 25, 2012. Note that 1102 and 1103 may be interchanged in the method 1100. Also, note that 1102 is optional in the method 1100.

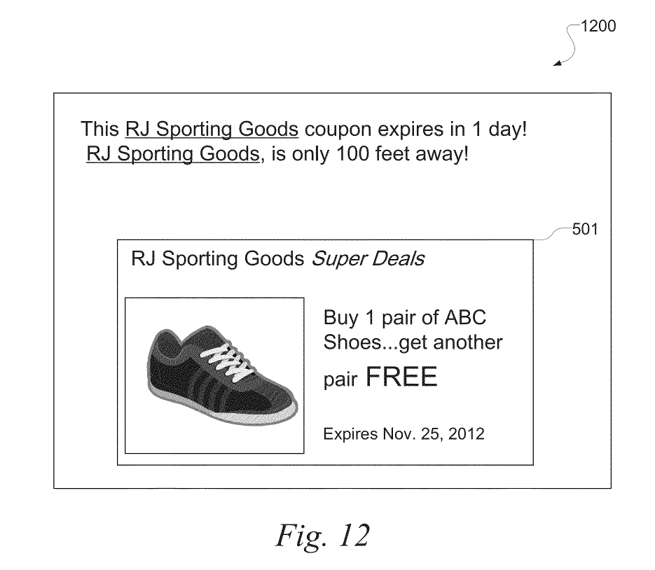

In 1104, the user interface module 204 displays a notification, via a user interface on a mobile device associated with the user, when the user is located within a predetermined distance of the redemption location (determined in 1102) and/or when the expiration time (determined in 1103) is within a predetermined time period of a current time. The notification may display the coupon, and inform the user of their proximity to the redemption location associated with the coupon and/or the amount of time remaining before the coupon expires. For example, FIG. 12 illustrates a notification 1200 that displays the coupon 501 that was included in the e-mail 500 (see FIG. 5). The notification 1200 informs the user of their proximity (e.g., “only 100 feet away”) to the redemption location or the “RJ Sporting Goods” retail store where the coupon 501 may be redeemed, and the amount of time remaining before the coupon 501 expires (e.g., “1 day”).

According to various embodiments, a user may share coupons received via email with others, so that when the user's friend is within a predetermined distance of the redemption location of a coupon, the aforementioned notification is displayed to the user's friend on their own mobile device.

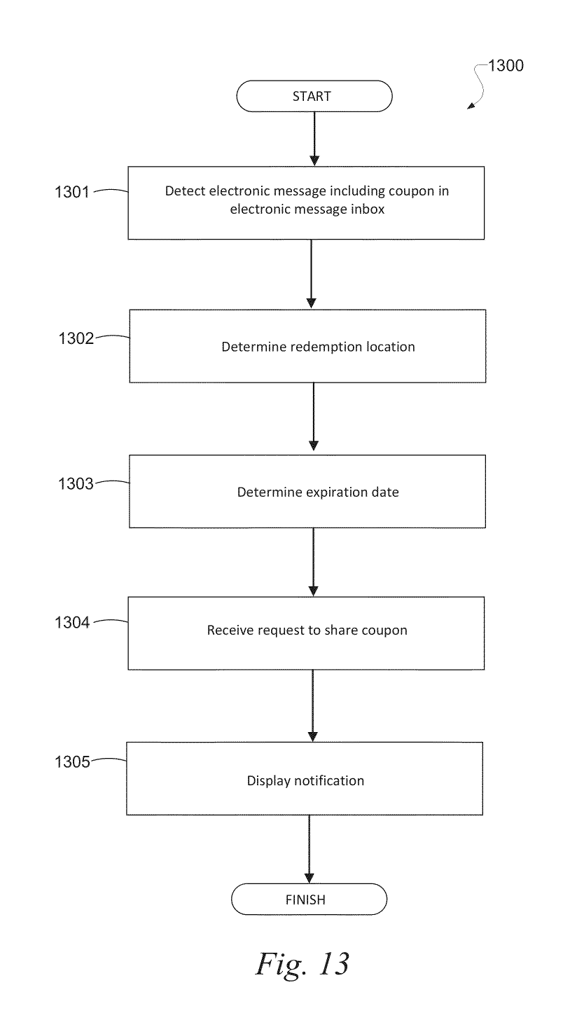

For example. FIG. 13 is a flowchart illustrating an example method 1300, according to various embodiments. The method 1300 may be performed at least in part by, for example, the coupon display system 200 illustrated in FIG. 2 (or an apparatus having similar modules, such as client machines 110 and 112 or application server 112 illustrated in FIG. 1). 1301-1303 in the method 1300 are substantially similar to 1201-1203 in the method 1200.

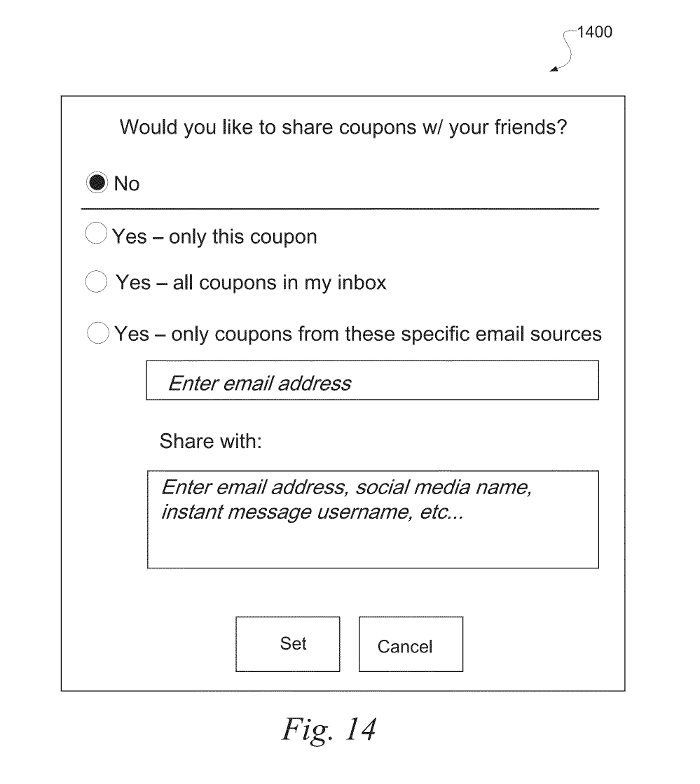

In 1304, the determination module 202 receives a request to share the coupon (detected in 1301), with an additional user. For example, suppose the email inbox of FIG. 4 is the inbox for the user “Jane Doe”, and thus the email message 500 including the coupon 501 was addressed to the user Jane Doe. The user interface module 204 may display a user interface (e.g., user interface 1400 illustrated in FIG. 14) that allows the user Jane Doe to request to share coupons received via email with specific contacts (e.g., by specifying their email addresses, social media handles, instant message screen names, and so forth). The user interface module 204 may display the user interface 1400 when, for example, the user Jane Doe logs into her e-mail inbox, views an e-mail in her e-mail inbox, views an e-mail in her e-mail inbox that contains a coupon (e.g., e-mail 500 in FIG. 5 that includes coupon 501), clicks on a coupon in an e-mail, clicks on a share button displayed by an email application or the coupon display system 200, etc.

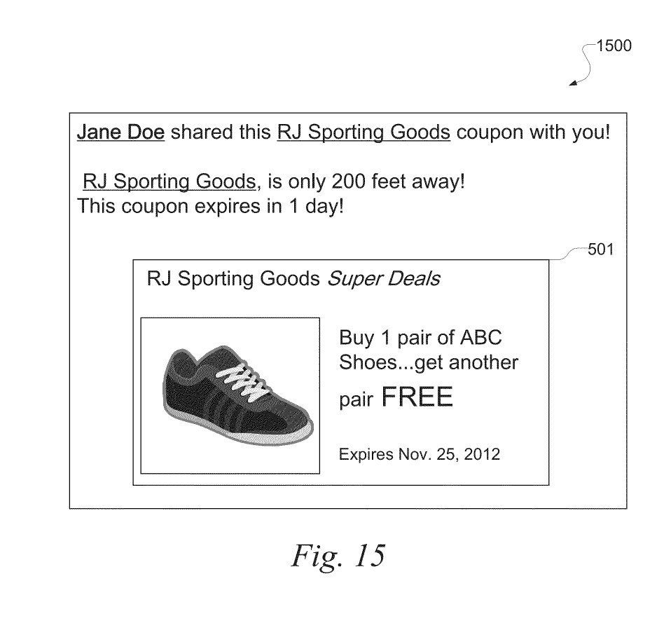

In 1305 in FIG. 13, the user interface module 204 displays a notification, via a user interface on a mobile device associated with the additional user, when the additional user is located within a predetermined distance of the redemption location (determined in 1302) and/or when the expiration time (determined in 1303) is within a predetermined time period of a current time. The notification may display the coupon, and inform the additional user of their proximity to the redemption location associated with the coupon the amount of time remaining before the coupon expires. For example, FIG. 15 illustrates a notification 1500 that displays the coupon 501 that was included in the e-mail 500 (see FIG. 5) received in the email inbox of, for example, the user “Jane Doe”. Thus, the notification 1500 identifies the user “Jane Doe” as a source of the coupon. The notification 1500 informs the additional user of their proximity (e.g., “only 200 feet away”) to the redemption location or the “RJ Sporting Goods” retail store where the coupon 501 may be redeemed, and the amount of time remaining before the coupon 501 expires (e.g., “1 day”).

Though arranged serially in the examples of FIGS. 3, 9a, 9b, 10, 11, and 13, other examples may reorder the operations, omit one or more operations, and/or execute two or more operations in parallel using multiple processors or a single processor organized as two or more virtual machines or sub-processors. Examples of FIGS. 3, 9a, 9b, 10, 11, and 13 can also be combined in whole or in part to form additional examples. Moreover, still other examples can implement the operations as one or more specific interconnected hardware or integrated circuit modules with related control and data signals communicated between and through the modules. Thus, any process flow is applicable to software, firmware, hardware, and hybrid implementations.

According to various embodiments described above, the user interface module 204 extracts a coupon from an e-mail (e.g., coupon 501 included in the e-mail 500 in FIG. 5), and displays a notification that includes the extracted coupon (e.g., see notification 800 illustrated in FIG. 8). According to another exemplary embodiment, the user interface module 204 may extract other portions of the e-mail that included the coupon (e.g., e-mail banner, subject line, source address, thumbnail of the e-mail, etc.), or obtain images or information regarding the product/service or retailer associated with the coupon (e.g., retailer masthead/logo, product manufacturer masthead/logo, product image, product information, etc.), and include this information in the notification.

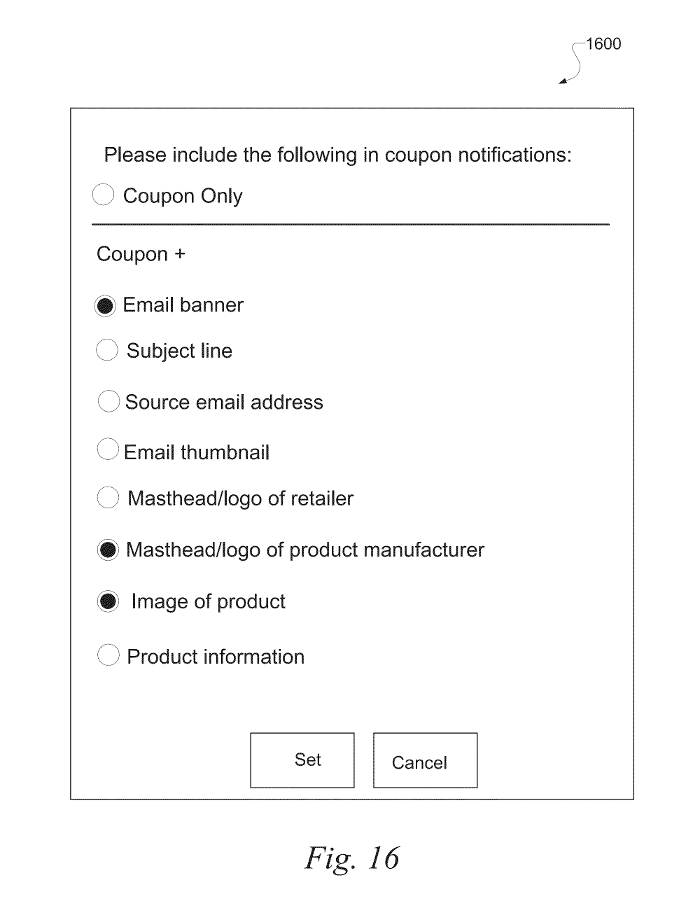

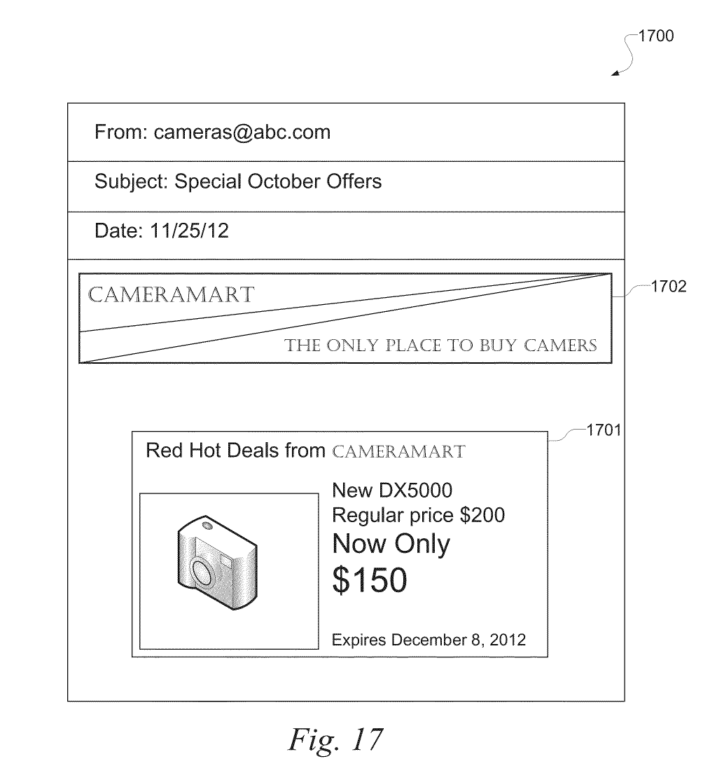

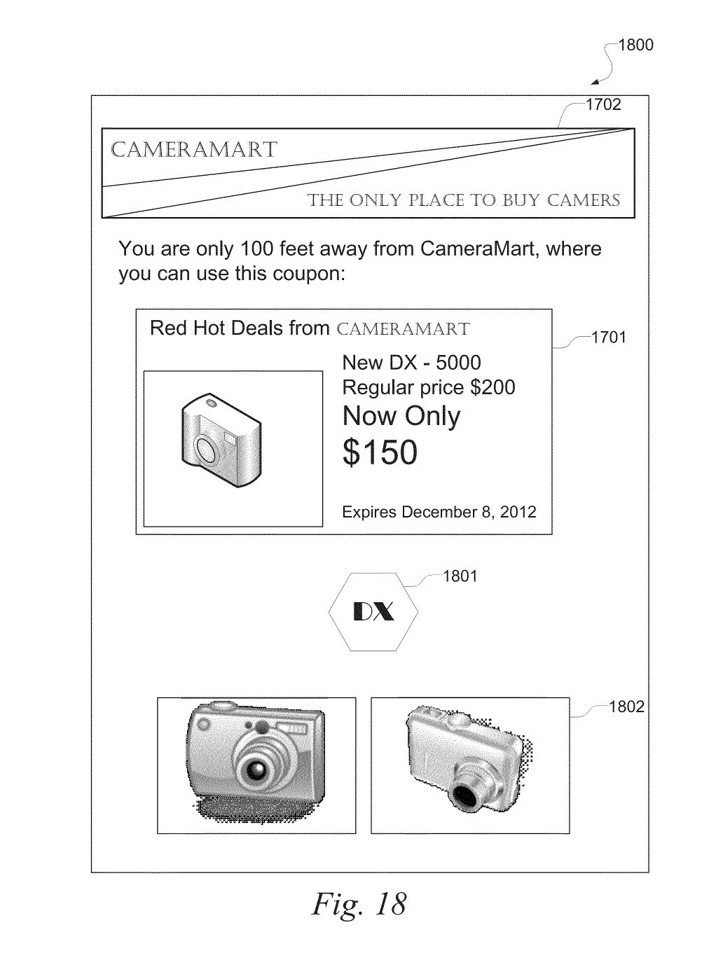

For example, the user interface module 204 may display the user interface 1600 illustrated in FIG. 16, that allows the user to define which portions of the e-mail that includes a coupon, and/or other information regarding the product, service, or retailer related to the coupon, should be included in any notification. Thus, if the user receives the e-mail 1700 in FIG. 17 which includes a coupon 1701 and an e-mail banner 1702, and if the user indicates (e.g., by selecting the appropriate user interface buttons in the user interface 1600) that notifications should include the coupon, e-mail banners, masthead/logos of the product manufacturer, and images of the product, then the user interface module 204 may display the notification 1800 in FIG. 18 that includes the coupon 1701, e-mail banner 1702, masthead/logo of the product manufacturer 1801 and images of the product 1802. The determination module 202 may obtain information regarding the product/service or retailer associated with the coupon (e.g., retailer masthead/logo, product manufacturer masthead/logo, product image, product information, etc.), by detecting product keywords, manufacturer keywords, retailer keywords, etc. in the e-mail message 1700 or coupon 1701, and by accessing a website associated with the product, manufacturer, retailer, etc., that contains such information.

While various embodiments of this disclosure describe electronic messages such as email messages, it is apparent that the aspects of this disclosure may be applied to other types of electronic messages, including text messages, short messages services (MMS) messages, multimedia message service (MMS) messages, instant messages, social media messages posted on an online social network service, and so on. In such case, the references to email addresses described throughout may be replaced by telephone numbers, instant message account handles, social media handles, and so on.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

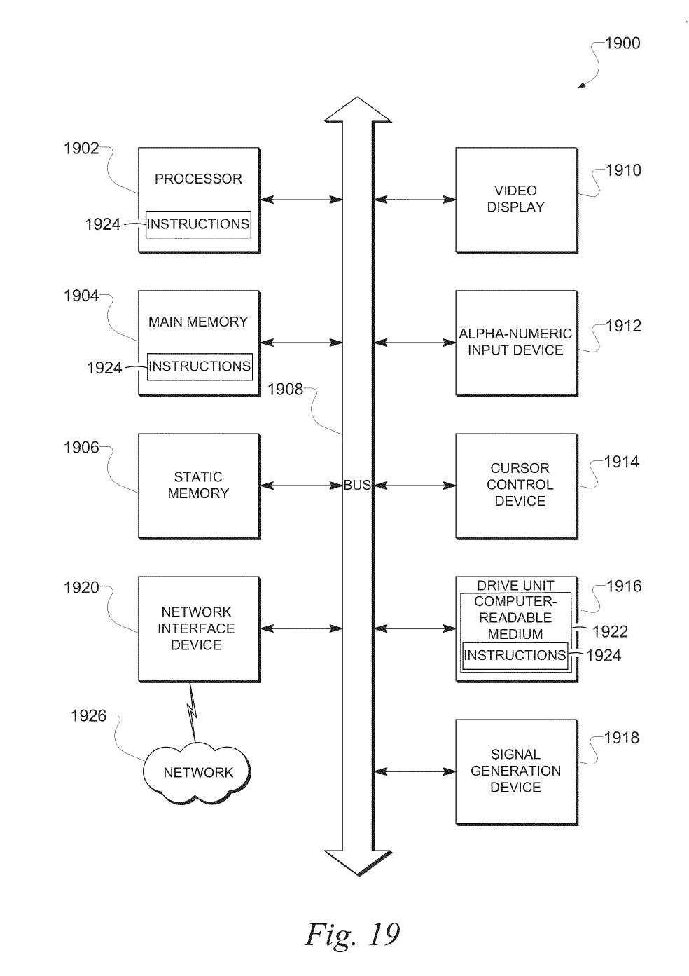

FIG. 19 is a block diagram of machine in the example form of a computer system 1900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard or a touch-sensitive display screen), a user interface (UI) navigation device 1914 (e.g., a mouse), a disk drive unit 1916, a signal generation device 1918 (e.g., a speaker) and a network interface device 1920.

### Machine-Readable Medium

The disk drive unit 1916 includes a machine-readable medium 1922 on which is stored one or more sets of instructions and data structures (e.g., software) 1924 embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media.

While the machine-readable medium 1922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1924 may further be transmitted or received over a communications network 1926 using a transmission medium. The instructions 1924 may be transmitted using the network interface device 1920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
detecting, in an electronic message inbox associated with a user, an electronic message including a coupon;
determining a redemption location associated with the coupon;
determining, on a mobile device, that the mobile device is located within a predetermined distance of the redemption location; and
displaying, in response to the determining that the mobile device is within a predetermined distance, a notification via a user interface on the mobile device associated with the user.

2. The method of claim 1, wherein the detecting comprises:
comparing a keyword included in content of the electronic message with a database listing a plurality of known coupon keywords; and
detecting a match between the keyword and one of the known coupon keywords.

3. The method of claim 1, wherein the detecting comprises:
comparing a message source address of the electronic message with a database listing a plurality of known coupon source addresses; and
detecting a match between the message source address and one of the known coupon source addresses.

4. The method of claim 1, wherein the determining of the redemption location comprises:
determining a specific retailer associated with the coupon; and
determining a location associated with the specific retailer.

5. The method of claim 4, wherein the determining of the specific retailer comprises:
comparing a keyword included in content of the electronic message with retailer information listing a plurality of names associated with a plurality of known retailers; and
detecting a match between the keyword and the name associated with the specific retailer.

6. The method of claim 4, wherein the location associated with the specific retailer is determined based on retailer information listing a plurality of known locations associated with a plurality of known retailers.

7. The method of claim 1, wherein the electronic message is at least one of an email message, a social media message, an instant message, and a text message.

8. The method of claim 1, wherein the electronic message inbox is at least one of an email message inbox, a social media message inbox, an instant message inbox, and a text message inbox.

9. The method of claim 1, further comprising:
determining an expiration time associated with the coupon; and
displaying the notification via the user interface on the mobile device, when the expiration time is within a predetermined time period of a current time.

10. The method of claim 1, further comprising:
receiving a request to share the coupon with an additional user; and
displaying an additional notification via a user interface on an additional mobile device associated with the additional user, when the additional mobile device is located within a predetermined distance of the redemption location.

11. The method of claim 10, wherein the additional notification displays the coupon and identifies the user as having shared the coupon.

12. The method of claim 1, further comprising:
receiving a request to share the coupon with an additional user; and
displaying an additional notification via a user interface on an additional mobile device associated with the additional user, when the expiration time is within a predetermined time period of a current time.

13. The method of claim 12, wherein the additional notification displays the coupon and identifies the user as having shared the coupon.

14. An apparatus comprising:
a determination module configured to:
detect, in an electronic message inbox associated with a user, an electronic message including a coupon;
determine a redemption location associated with the coupon; and
determine that a mobile device of the user is located within a predetermined distance of the redemption location, and
a user interface module configured to display, in response to the determining that the mobile device is within the predetermined distance, a notification via a user interface on the mobile device associated with the user.

15. The apparatus of claim 14, wherein the determination module is further configured to:
compare a keyword included in content of the electronic message with a database listing a plurality of known coupon keywords; and
detect a match between the keyword and one of the known coupon keywords.

16. The apparatus of claim 14, wherein the determination module is further configured to:
determine an expiration time associated with the coupon; and
display the notification via the user interface on the mobile device, when the expiration time is within a predetermined time period of a current time.

17. The apparatus of claim 14, wherein the determination module is further configured to:
receive a request to share the coupon with an additional user; and
display an additional notification via a user interface on an additional mobile device associated with the additional user, when the additional mobile device is located within a predetermined distance of the redemption location.

18. The apparatus of claim 17, wherein the additional notification displays the coupon and identifies the user as having shared the coupon.

19. The apparatus of claim 14, wherein the determination module is further configured to:
receive a request to share the coupon with an additional user; and
display an additional notification via a user interface on an additional mobile device associated with the additional user, when the expiration time is within a predetermined time period of a current time.

20. A non-transitory machine-readable storage medium having embodied thereon instructions executable by one or more machines to perform operations comprising:
detecting, in an electronic message inbox associated with a user, an electronic message including a coupon;
determining a redemption location associated with the coupon;
determining, on a mobile device, that the mobile device is located within a predetermined distance of the redemption location; and
displaying, in response to the determining that the mobile device is within a predetermined distance, a notification via a user interface on the mobile device associated with the user.
